(19) United States
(12) Patent Application Publication
(10) Pub. No.: US 2013/0100500 A1
(43) Pub. Date: Apr. 25, 2013

(54) DEVICE CONTROL SYSTEM, ELECTRONIC DEVICE, AND DEVICE CONTROL METHOD

(71) Applicant: Negishi YUUICHIROH, Kawasaki (JP)

(72) Inventor: Negishi YUUICHIROH, Kawasaki (JP)

(21) Appl. No.: 13/656,082

(22) Filed: Oct. 19, 2012

(30) Foreign Application Priority Data
Oct. 19, 2011 (JP) 2011-229741
Oct. 15, 2012 (JP) 2012-227716

(51) Int. Cl. G06K 15/02

(52) U.S. Cl. 358/1.16

(57) ABSTRACT

An electronic device connectable to a control device and an external storage device. The electronic device includes a request receiving unit configured to receive a request for obtaining information from the control device, a gathering unit configured to gather information based on the received request, a determining unit configured to determine whether the received request is requesting information larger than a predetermined size, and a sending unit configured to send the gathered information to the external storage device when the determining unit determines that the received request is requesting information larger than the predetermined size, and configured to send the gathered information to the control device when the determining unit determines that the received request is not requesting information larger than the predetermined size.

### CROSS-REFERENCE TO RELATED APPLICATIONS

The present application claims priority under 35 U.S.C. §119(a) to Japanese Patent Application No. 2011-229741 filed in Japan on Oct. 19, 2011 and 2012-227716 filed in Japan on Oct. 15, 2012. The entire contents of Japanese Patent Application Nos. 2011-229741 and 2012-227716 are hereby incorporated by reference.

### BACKGROUND

1. Technological Field

The exemplary embodiments described herein relate to a device control system including an electronic device and a control device, wherein, the control device controls the electronic device.

2. Description of the Related Art

Japanese Patent No. 4318975 describes a remote control system which includes a plurality of image forming apparatus and a control server for controlling the plurality of image forming apparatus remotely.

In this remote control system, when an error occurs on one of the plurality of image forming apparatus, the image forming apparatus in which the error occurred sends information regarding the error to the control server.

### SUMMARY

However, in conventional remote control system, the image forming apparatus in which the error occurred sends the information regarding the error to the control server regardless of a size of the information.

Thus, when the size of information to be sent is large, network traffic between the image forming apparatus and the control server is increased. Furthermore, the increased traffic affects performance of all of the remote control system.

Exemplary embodiments described herein provide a device control system, an electronic device, and a device control method.

A device control system including a control device and an electronic device. The electronic device of the device control system including: a request receiving unit configured to receive a request for obtaining information from the control device; a gathering unit configured to gather information based on the received request; a determining unit configured to determine whether the received request is requesting information larger than a predetermined size; a sending unit configured to send the gathered information to an external storage device different from the control device when the determining unit determines that the received request is requesting information larger than the predetermined size, and configured to send the gathered information to the control device when the determining unit determines that the received request is not requesting information larger than the predetermined size.

The control device of the device control system may also include: a first request sending unit configured to send the request for obtaining information to the electronic device.

An electronic device connectable to a control device and an external storage device, the electronic device including: a request receiving unit configured to receive a request for obtaining information from the control device; a gathering unit configured to gather information based on the received request; a determining unit configured to determine whether the received request is requesting information larger than a predetermined size; a sending unit configured to send the gathered information to the external storage device when the determining unit determines that the received request is requesting information larger than the predetermined size, and configured to send the gathered information to the control device when the determining unit determines that the received request is not requesting the information larger than the predetermined size.

A device control method on an electronic device, the method including: receiving a request for obtaining information from a control device connected to the electronic device; gathering information based on the received request on the electronic device; determining whether the received request is requesting information larger than a predetermined size; sending the gathered information to an external storage device different from the control device when the determining determines that the received request is requesting information larger than the predetermined size, and the gathered information to the control device when the determining determines that the received request is not requesting information larger than the predetermined size.

In the device control system, the electronic device may send the normal sized information to the control device and sends the large sized information to the external storage device different from the control device.

Thus, network traffic between the electronic device and the control device is not increased.

### BRIEF DESCRIPTION OF THE DRAWINGS

FIG. 1 is a diagram illustrating an exemplary system configuration of a device control system;

FIG. 2 is a block diagram of an exemplary hardware configuration of a control device and a storage apparatus;

FIG. 3 is a block diagram of an exemplary hardware configuration of an electronic device;

FIG. 4 is a diagram illustrating an exemplary function configuration of the control device, the storage apparatus, and the electronic device;

FIG. 5 is a sequence diagram illustrating an exemplary procedure for a process storing information in the control device or the storage apparatus; and

FIG. 6 is a sequence diagram illustrating an exemplary procedure for a process displaying the information stored in the control device.

### DETAILED DESCRIPTION OF THE PREFERRED EMBODIMENTS

Hereinafter, exemplary embodiments will be described with reference to the accompanying drawings. However, these exemplary embodiments are not limiting, and variations and modifications may be made without departing from the basic concepts of the present technological advancement.

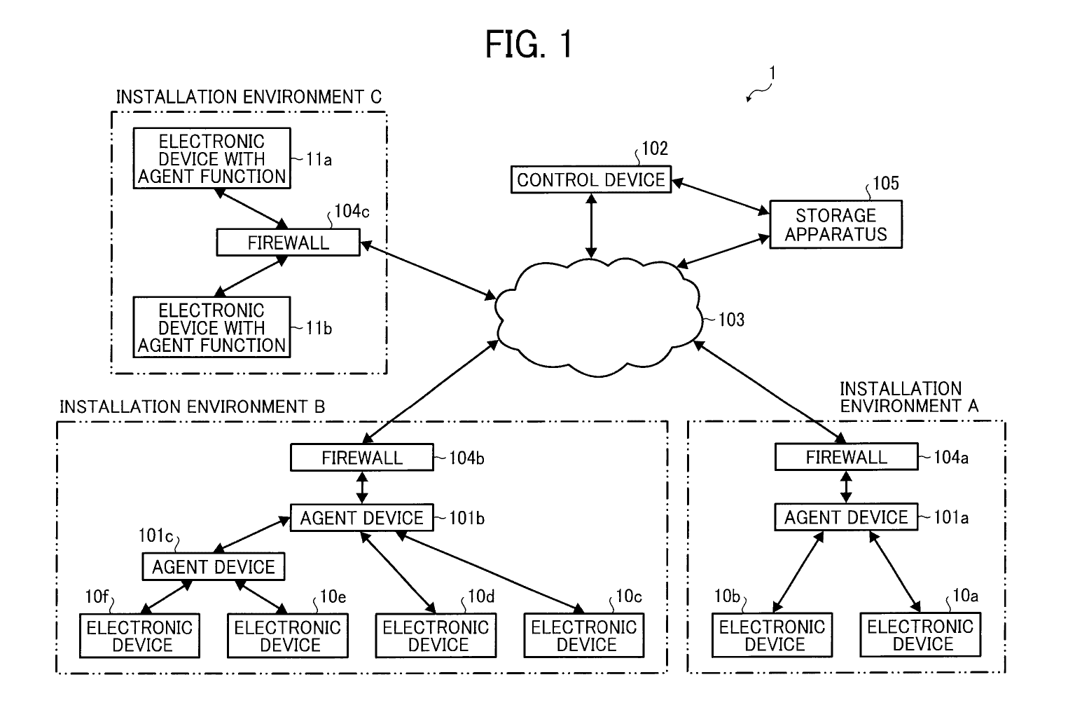

FIG. 1 is a block diagram of an exemplary system configuration of a device control system 1.

As illustrated in FIG. 1, the device control system 1 includes installation environments A, B, and C, which include an electronic device 10a, an electronic device 10b, an electronic device 10c, an electronic device 10d, an electronic device 10e, an electronic device 10f, an electronic device with agent function 11a, an electronic device with agent function 11b, an agent device 101a, an agent device 101b, an agent device 101c, firewalls 104a and 104b, a control device 102, and a storage apparatus 105.

Reference to electronic device 10 indicates all of the electronic devices 10a-10f, 11a, and 11b, unless specified otherwise. Reference to agent device 101 indicates all of the agent devices 101a, 101b, and 101c, unless specified otherwise.

The electronic device 10 is connected to the control device 102 via the agent device 101 and internet 103. Further, the electronic device 10 is controlled by the control device 102. Further, the electronic device 10 sends large sized information to the storage apparatus 105 in response to a request from the control device 102. Further, the electronic device 10 sends normal sized information to the control device 102 in response to a request from the control device 102.

For example, the electronic device 10 may include one or more of a printer, facsimile device, multi functional peripheral (MFP), projector, television, automatic vending machine, medical device, power supply device, air conditioning system, and an measuring system for gas and water. The electronic devices 10 included in the embodiment in FIG. 1 are not all necessarily the same type of device.

The agent device 101 is connected to the electronic device 10 via a local area network (LAN). Further, the agent device 101 mediates a control from the control device 102 to the electronic device 10. For example, the agent device 101 obtains information from the electronic device 10 in response to a request from the control device 102, and sends the obtained information to the control device 102.

The control device 102 is connected to the agent device 101 via internet 103. In the control system 1, the control device 102 controls the electronic device 10 via the agent device 101. Further, the control device 102 obtains the large sized information from the storage apparatus 105, and controls the electronic device 10 based on the obtained large sized information. Further, the control device 102 controls the electronic device 10 based on the normal sized information sent from the electronic device 10.

In this embodiment, the large sized information is the information larger than a predetermined size on the control system 1. Further, the normal sized information is the information less than the predetermined size. For example, the large sized information includes all of setting information, log information of all users, image data stored in the electronic device 10, and movie data stored in the electronic device 10. These are merely examples, and large sized information may include more or less information. The predetermined size may be defined by a network administrator in view of managing bandwidth and the volume of the data being transmitted across the network. The predetermined size may refer to megabytes, gigabytes, etc., or categories of information included in the transmission (e.g., the characterization of large size information given above).

The embodiment of FIG. 1 shows multiple installation environment, which include one or more electronic devices 10. For example, in installation environment A, the agent device 101a is able to establish connection with the control device 102 by using HTTP (Hyper Text Transfer Protocol). Further the agent device 101a is connected to the electronic device 10a and the electronic device 10b.

In installation environment B, four electronic devices are installed in this installation environment, and two agent devices are installed in this installation. Further, these agent devices are installed hierarchically.

In installation environment C, the electronic device with agent function 11a and 11b are connected to the control device 102 directly. The electronic device with agent function 11a and 11b includes an agent function as the agent device 101.

Further, each installation environment installs firewall 104. The firewall 104 includes a proxy server.

In the device control system, an application program which controls the electronic device 10 is installed in the agent device 101. Further, an application program which controls the agent device 101 and the electronic device 10 is installed in the control device 102. Further, each of these application programs sends a request to other application programs, and receive a response to the request from the other application programs. Thus, the electronic device 10 generates a request and sends the request to the control device 102, and receives a response to the sent request from the control device 102. Meanwhile, the control device 102 generates a request and sends the request to the agent device 101, and receives a response to the request from agent device 101.

For example, these connections are realized by SOAP (Simple Object Access Protocol), HTTP, FTP (File Transfer Protocol), COM (Component Object Model), CORBA (Common Object Request Broker Architecture).

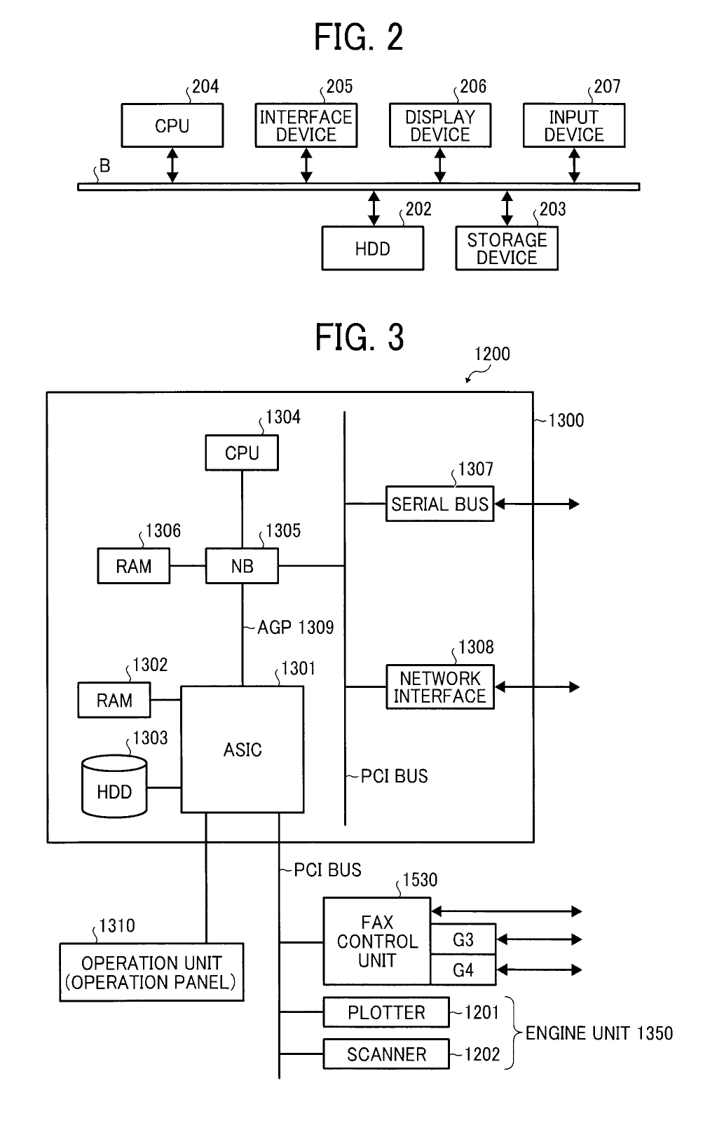

FIG. 2 is a block diagram of an exemplary hardware configuration of the agent device 101, control device 102, and the storage apparatus 105. The agent device 101, control device 102, and storage apparatus 105 will each include respective programming, stored in storage device 203, to implement the functionality described herein. The agent device 101, the control device 102, and the storage apparatus 105 does not necessarily have every element shown in FIG. 2.

As illustrated in FIG. 2, each device may include a HDD (Hard Disk Drive) 202, a storage device 203, a CPU (Central Processing Unit) 204, an interface device 205, a display device 206, input device 207, which are mutually connected to each other by a bus B.

The HDD 202 stores a program to be executed on each device. Further, the HDD 202 stores file and data.

The storage device 203 stores the programs read by CPU 204 from HDD 202.

The CPU 204 reads the program stored in the HDD and executes the read program.

The interface device 205 is an interface which connects to a network.

The display device 206 displays GUI (Graphical User Interface).

The input device 207 receives a user operation by a user. For example, the input device 207 includes a keyboard and a mouse.

FIG. 3 is a block diagram of an exemplary hardware configuration of an image forming apparatus as the electronic device 10.

As illustrated in FIG. 3, the image forming apparatus 1200 includes an operation unit (operation panel) 1310, a FAX control unit 1530, a plotter 1201, a scanner 1202, and a controller 1300.

The operation unit 1310 receives a user operation from a user, and displays various data. The FAX control unit 1503 controls a facsimile function. The plotter 1201 prints an image on the printing medium. The scanner 1202 scans a document and creates image data based on the scanned document.

The controller 1300 includes an ASIC (Application Specific Integrated Circuit) 1301, a RAM (Random Access Memory) 1302, a HDD (Hard Disk Drive) 1303, a CPU (Central Processing Unit) 1304, a NB (North Bridge) 1305, a RAM (Random Access Memory) 1306, a serial bus 1307, and a network interface 1308.

The CPU 1304 controls all processes on the image forming apparatus 1200. The NB 1305 is a bridge to connect CPU 1304 to the ASIC 1301, the RAM 1306, the serial bus, and the network interface 1308.

The RAM 1306 is a volatile semiconductor memory which stores programs and data temporarily.

The serial bus 1307 is an interface to connect to an external device. The RAM 1302 is a volatile semiconductor memory. The RAM 1302 is used as buffer by ASIC 1301. The HDD 1303 stores image data, a program, and font data.

The ASIC 1301 is an integrated circuit for image processing. The network interface 1308 connects to an external apparatus via a network. Further, the ASIC 1301 includes a RAM interface for connecting to the RAM 1302 and a hard disk interface for connecting to the HDD 1303. Further, the ASIC 1303 is connected to the NB 1305 via an AGP (Accelerated Graphics Port) bus 1309.

A function configuration of the device control system 1 will be described below.

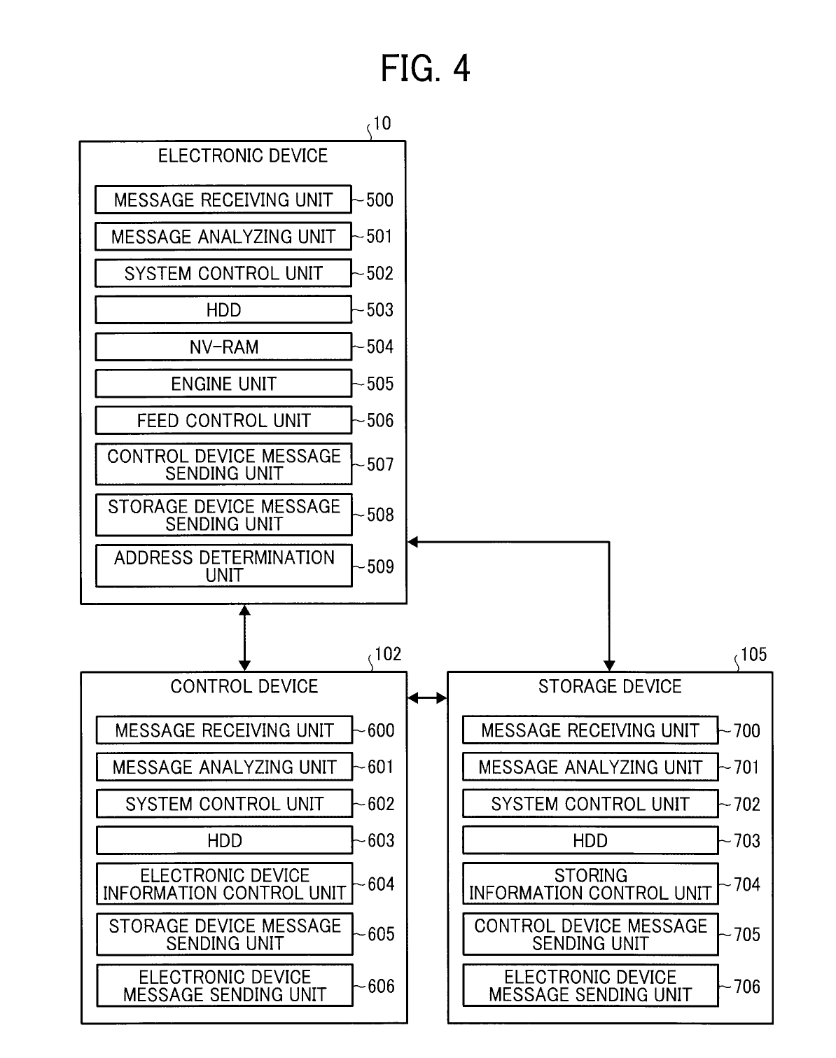

FIG. 4 is a diagram illustrating the function configuration of the electronic device 10, control device 102 and the storage apparatus 105.

First, the function configuration of the electronic device 10 will be described below.

As illustrated in FIG. 4, the electronic device 10 includes a message receiving unit 500, a message analyzing unit, a system control unit, a HDD (Hard Disk Drive) 503, a NV-RAM (Non Volatile Random Access Memory) 504, an engine unit 505, a feed control unit 506, a control device message sending unit 507, a storage device message sending unit 508, and an address determination unit 509.

The message receiving unit 500 receives a control message sent from the control device 102 and a message sent from the storage apparatus 105. For example, the control message includes a request for obtaining the large sized information and a request for obtaining the normal sized information.

The message analyzing unit 501 analyzes the message received by the message receiving unit 500. The system control unit 502 executes the message analyzed by the analyzing unit 501.

The HDD 503 and the NV-RAM 504 store setting information, image data, and log information.

The engine unit 505 includes a sensor to detect an error for imaging. Further, the engine unit 505 detects the error for imaging by using the sensor.

The feed control unit 506 includes a sensor to detect an error for feeding. Further, the feed control unit 506 detects the error for feeding by using the sensor. According to the detection of these errors, the control device 102 is able to determine whether an error has occurred on the electronic device 10. Further, the control device 102 is able to determine a type of the error. Therefore, the control device 102 is able to control the electronic device 10 remotely.

For example, when the engine unit 505 detects the error for imaging or the feed control unit 506 detects the error for feeding, the electronic device 10 sends error information to the control device 102. Further, the control device 102 determines, based on the error information sent from the electronic device 10, whether information to be obtained from the electronic device 102 is the large sized information. Further, the electronic device 10 sends the normal sized information to the control device 102 in response to the request for obtaining the normal sized information sent from the control device 102. Further, the electronic device 10 sends the large sized information to the storage apparatus 105 in response to the request for obtaining the large sized information sent from the control device 102. In other words, the control device 102 may control the electronic device 10 by controlling when the electronic device transmits the error information and the format in which the electronic device 10 transmits the error information (large size or normal size).

According to the sending process, communication traffic between the control device 102 and the electronic device is reduced.

The control device message sending unit 507 sends a message to the control device 102. The storage apparatus message sending unit 508 sends the large sized information to the storage apparatus 105.

The address determination unit 509 determines an address to send the large sized information or the normal sized information.

Next, the function configuration of the control device 102 will be described below.

As illustrated in FIG. 4, the control device 102 includes a message receiving unit 600, a message analyzing unit 601, system control unit 602, a HDD 603, a device information control unit 604, a storage apparatus message sending unit 605, and an electronic device message sending unit 606.

The message receiving unit 600 receives a message sent from the electronic device 10, the message includes the error information and normal sized information. Further, the message receiving unit 600 receives, from the storage apparatus 105, the large sized information which is the sent from the electronic device 10 to the storage apparatus 105 and stored in the storage apparatus 105.

The message analyzing unit 601 analyzes the message received by the message receiving unit 600.

The HDD 603 stores the message received by the message receiving unit 600. Further, the HDD 603 stores the normal sized information.

The system control unit 602 executes a control process based on the analyzed message.

The device information control unit 604 controls the message sent from the electronic device 10.

The storage apparatus message sending unit 605 sends, to the storage apparatus 105, a request for obtaining the large sized information stored in the storage apparatus 105.

The electronic device message sending unit 606 sends, to the electronic device 10, the request for obtaining the large sized information and the request for obtaining the normal sized information. Further, the electronic device message sending unit 606 is able to send an address of the storage apparatus 105 together with the massage for obtaining the large sized information.

Next, the function configuration of the storage apparatus 105 will be described below.

As illustrated in FIG. 4, the storage apparatus 105 includes a message receiving unit 700, a message analyzing unit 701, a system control unit 702, a HDD 703, a storing information control unit 704, a control device message sending unit 705, and an electronic device message sending unit 706.

The message receiving unit 700 receives a message sent from the electronic device 10 and the control device 102, Further the message receiving unit 700 receives the large sized information sent from the electronic device 10. Further, the message receiving unit 700 receives the request for obtaining the large sized information sent from the control device 102.

The message analyzing unit 701 analyzes the message received by the message receiving unit 700. The system control unit 702 executes the message analyzed by the message analyzing unit 701.

The HDD 703 stores the message received by the message receiving unit 700. Further, the HDD 703 stores the large sized information sent from the electronic device 10.

The storing information control unit 704 searches the large sized information stored in the HDD 703. The control device message sending unit 705 sends the large sized information searched by the storing information control unit 704 to the control device 102.

The electronic device message sending unit 706 sends a message to the electronic device 10.

A detailed process of the device control system according to this embodiment will be described below with reference to a sequence diagram.

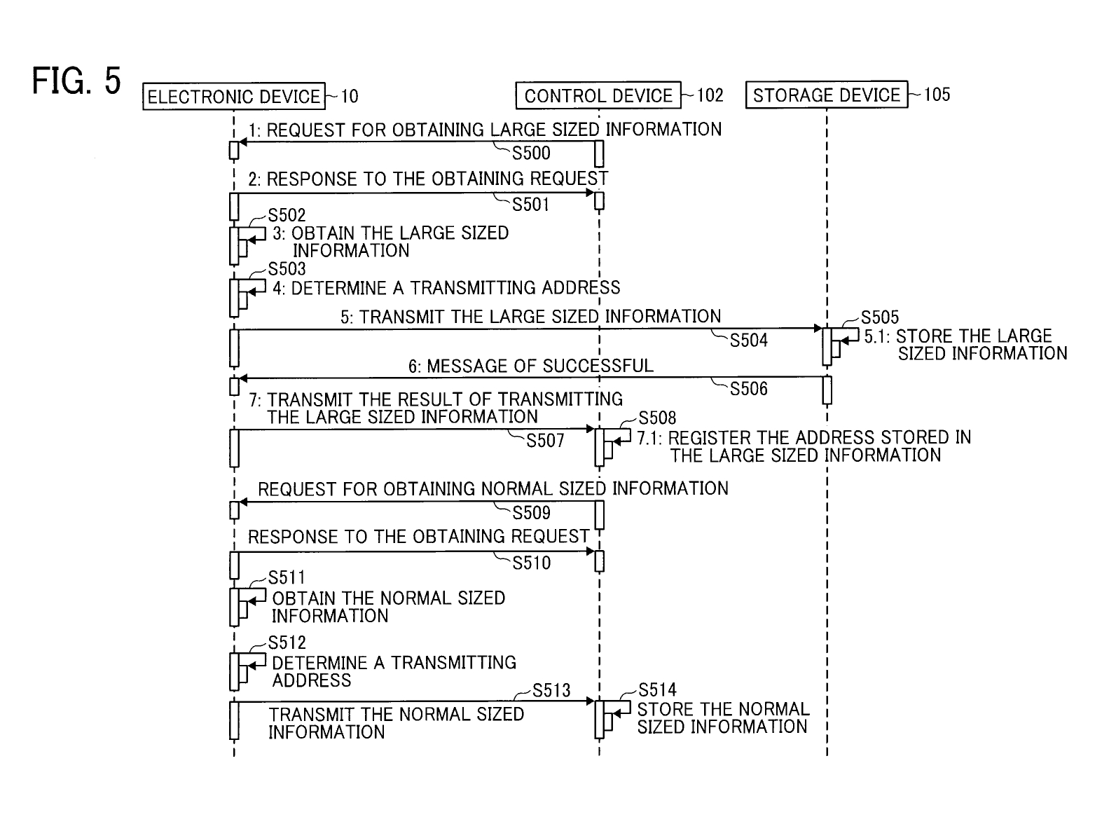

FIG. 5 is a sequence diagram illustrating a procedure for controlling of electronic device according to this embodiment.

As illustrated in FIG. 5, when the control device 102 received error information from electronic device 10, the control device 102 determines, based on the received error information whether the control device 102 should obtain the large sized information from the electronic device 10. Further, when the control device 102 determines the control device 102 should obtain the large sized information, the control device 102 sends a request for obtaining the large sized information to the electronic device 10 (step S500).

Next, in response to the request for obtaining the large sized information sent from the control device 102, the electronic device 10 sends, to the control device 102, a message that the electronic device 10 is able to send the requested large sized information (step S501).

Next, the electronic device 10 gathers the large sized information based on the request for obtaining the large sized information sent from the control device 102 (step S502).

Next, the electronic device 10 determines an address to which the large sized information is to be sent (step S503). In detail, the address is determined by the address determination unit 509. The address determination unit 509 is able to determine the address based on a predetermined address stored in the HDD 503. Further, when the request for obtaining the large sized information sent from the control device 102 includes an address to send the large sized information, the address determination unit 509 is able to determine the address based on the address included in the message. Further, when the electronic device 10 receives a request for obtaining the normal sized information, the address determination unit 509 determines that the address to be sent the normal sized information is the control device 102.

Next, when the address at which the large sized information is to be sent is determined by the address determination unit 509, the electronic device 10 sends the gathered large sized information to the determined address (step S504). Further, the electronic device 10 is able to include identification information to identify the gathered large sized information in the gathered large sized information.

Next, the storing apparatus 105 stores the large sized information sent from the electronic device 10 in the HDD 703 (step S505).

Next, the storing apparatus 105 sends, to the electronic device 10, a result of storing and identified information for identifying the stored large sized information (step S506). For example, the identified information is a serial ID or an URL.

Next, in response to the result sent from the storage apparatus 105, the electronic device 10 sends, to the control device 102, the identified information sent from the storage apparatus 105 and the address determined by the address determination unit 509 (step S507).

Next, the control device 102 stores the identified information and the address sent from the electronic device 10 in the HDD 603 (step S508).

Next, when the control device 102 received error information from electronic device 10, the control device 102 determines, based on the received error information whether the control device 102 should obtain the large sized information from the electronic device 10. Further, when the control device 102 determines the control device 102 should not obtain the large sized information, the control device 102 sends a request for obtaining the normal sized information to the electronic device 10 (step S509).

Next, in response to the request for obtaining the normal sized information sent from the control device 102, the electronic device 10 sends, to the control device 102, a message that the electronic device 10 is able to send the requested normal sized information (step S510).

Next, the electronic device 10 gathers the normal sized information based on the request for obtaining the normal sized information sent from the control device 102 (step S511).

Next, the electronic device 10 determines an address at which the normal sized information is to be sent (step S512). In detail, the address is determined by the address determination unit 509. The address determination unit 509 determines the address at which the normal sized information is to be sent is the control device 102, because the request received from the control device is the request for obtaining the normal sized information.

Next, when the address at which the normal sized information is to be sent is determined by the address determination unit 509, the electronic device 10 sends the gathered normal sized information to the control device 102 (step S513).

Next, the control device 102 stores the normal sized information sent from the electronic device 10 in the HDD 603 (step S514).

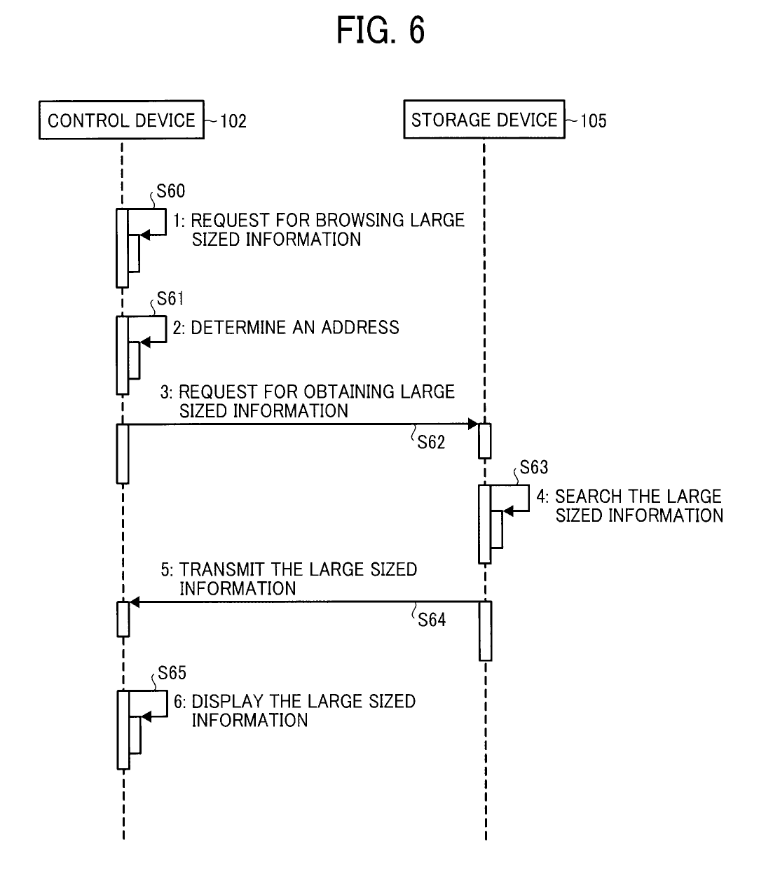

FIG. 6 is a sequence diagram illustrating a procedure for displaying the large sized information stored in the storage apparatus 105 according to this embodiment.

As illustrated in FIG. 6, the control device 102 activates the process for displaying the large sized information (step S60).

Next, the control device 102 determines the address at which the large sized information to be obtained is stored (step S61).

Next, the control device 102 sends, to the storage apparatus, an obtaining request including the identified information of the large sized information to be obtained (step S62).

Next, when the storage apparatus receives the obtaining request sent from the control device 102, the storage apparatus searches for the large sized information by the identified information included in the obtaining request (step S63).

Next, the control apparatus 105 obtains the searched for large sized information from the HDD 703 and sends the obtained large sized information to the control device 102 (step S64).

Next, the control device displays the large sized information sent from the storage apparatus 105 on the display device 206 (step S65).

As described above, when the control device 102 obtains the large sized information from the electronic device 10, the electronic device 10 sends the large sized information to the storage apparatus 10 different from the control device 102. Further, the control device 102 obtains the large sized information from the control device 105. Thus, according to the described device control system, the network traffic between the electronic device 10 and the control device 102 is able to be reduced.

Finally, the embodiments described herein are only examples, and variations and modifications may be made without departing from the concepts discussed herein.

What is claimed is:

1. A device control system comprising: a control device including a first request sending unit configured to send a request for obtaining information; and
an electronic device that includes,
a request receiving unit configured to receive the request for obtaining information from the control device,
a gathering unit configured to gather information based on the received request,
a determining unit configured to determine whether the received request is requesting information larger than a predetermined size, and
a sending unit configured to send the gathered information to an external storage device different from the control device when the determining unit determines that the received request is requesting information larger than the predetermined size, and configured to send the gathered information to the control device when the determining unit determines that the received request is not requesting information larger than the predetermined size.

2. The device control system as claimed in claim 1, wherein
the control device further comprises:
a storing control unit configured to store information on a storage device,
wherein
the sending unit is further configured to send, when the gathered information is sent to the external storage device, an identifier of the gathered information stored at the external storage device to the control device, and the storing control unit stores the identifier sent from the sending unit.

3. The device control system as claimed in claim 2, wherein the control device further comprises:
a second request sending unit configured to send a request for obtaining information and the identifier to the external storage device; and
a receiving unit configured to receive the information from the external storage device in response to the request sent by the second request sending unit and the identifier.

4. The device control system as claimed in claim 3, wherein the control device further comprises:
a display unit configured to display the information received by the receiving unit and the information sent form the electronic device.

5. The device control system as claimed in claim 1, wherein the electronic device further comprises:
an address determining unit configured to determine an address to send the information to, wherein
the address determining unit determines that the address to send the information to is an address of the external storage device when the determining unit determines that the received request is the request to obtain the information larger than the predetermined size, and determines that the address to send the information to is an address of the control device when the determining unit determines that the received request is not the request to obtain the information larger than the predetermined size, and
the sending unit sends the gathered information to the determined address.

6. The device control system as claimed in claim 5,
wherein
the first request sending unit sends, when the first request sending unit sends the request to obtain the information larger than the predetermined size, the address of the external storage device to the electronic device together with the request,
the request receiving unit receives the address of the external storage device sent from the first sending unit, and
the address determining unit determines that the address to send the information to is the received address.

7. An electronic device connectable to a control device and an external storage device, the electronic device comprising:
a request receiving unit configured to receive a request for obtaining information from the control device;
a gathering unit configured to gather information based on the received request;
a determining unit configured to determine whether the received request is requesting information larger than a predetermined size; and
a sending unit configured to send the gathered information to the external storage device when the determining unit determines that the received request is requesting information larger than the predetermined size, and configured to send the gathered information to the control device when the determining unit determines that the received request is not requesting information larger than the predetermined size.

8. The electronic device as claimed in claim 7, wherein
the sending unit is further configured to send, when the gathered information is sent to the external storage device, an identifier of the gathered information stored at the external storage device to the control device.

9. The device control system as claimed in claim 7,
further comprising:
an address determining unit configured to determine an address to send the information to; and
wherein
the address determining unit determines that the address to send the information to is an address of the external storage device when the determining unit determines that the received request is the request to obtain the information larger than the predetermined size, and determines that the address to send the information to is an address of the control device when the determining unit determines that the received request is not the request to obtain the information larger than the predetermined size, and
the sending unit sends the gathered information to the determined address.

10. A device control method on an electronic device, comprising:
receiving a request for obtaining information from a control device connected to the electronic device;
gathering information based on the received request on the electronic device;
determining whether the received request is requesting information larger than a predetermined size; and
sending the gathered information to an external storage device different from the control device when the determining determines that the received request is requesting information larger than the predetermined size, and the gathered information to the control device when the determining determines that the received request is not requesting information larger than the predetermined size.

11. The device control method as claimed in claim 10,
further comprising:
sending, when the gathered information is sent to the external storage device, an identifier of the gathered information stored at the external storage device to the control device.
